(19) United States
(12) Patent Application Publication
(10) Pub. No.: US 2005/0288485 A1
(43) Pub. Date: Dec. 29, 2005

(54) Method and apparatus for pretreatment of polymeric materials utilized in carbon dioxide purification, delivery and storage systems

(76) Inventors: Jerry Michael Mahl, Youngstown, NY (US); Karen Anne Connery, Willowbrook, IL (US); Thomas John Bergman JR., Clarence Center, NY (US)

Correspondence Address: PRAXAIR TECHNOLOGY, INC.;Law Department M1-557, 39 Old Ridgebury Road, Danbury, CT, 06810-5113, US

(21) Appl. No.: 10/874,374

(22) Filed: Jun. 24, 2004

(51) Int. Cl. C01B 17/16; B01J 8/04

(52) U.S. Cl. 528/490; 422/188; 422/168; 422/224

(57) ABSTRACT

The present invention relates to a method and apparatus for pretreating a polymeric material in a treatment chamber. The method includes providing a polymeric material component into the treatment chamber and introducing a carbon dioxide fluid in supercritical state therein. The component is exposed to the carbon dioxide fluid to extract non-volatile organic residue contained in the component. The contaminated carbon dioxide fluid containing the extracted non-volatile organic residue is removed from the treatment chamber such that the organic residue does not deposit onto the polymeric material component by depressurizing the treatment chamber. Thereafter, the component is removed from the treatment chamber.

### FIELD OF THE INVENTION

This invention relates to pretreatment of polymeric materials utilized in the pharmaceutical and semiconductor industries where the fabrication of the ultimate product under high purity conditions is imperative. In particular, the invention relates to the removal of non-volatile organic residues from polymeric materials.

### BACKGROUND OF THE INVENTION

Carbon dioxide supplied to food and beverage customers normally meets a purity specification known as Enhanced Ingredient Grade (EIG). Carbon dioxide of this purity is sufficient for use in the food and beverage industry, and most existing plants are capable of producing same. However, some applications such as in the fields of pharmaceutical and semiconductor processing (e.g., photoresist removal, wafer cleaning, microelectromechanical systems (MEMS) drying, and metal target cleaning) require ultra-high-purity (UHP) grade carbon dioxide. The term “ultra-high-purity”, as utilized herein will be understood to mean a carbon dioxide stream that contains relevant contaminants in a concentration of around 2 part per million (ppm) by weight or less.

Carbon dioxide contaminants can also include non-volatile residue (NVR). As used herein, the term “non-volatile residue” refers to that contaminant portion that remains following sublimation or evaporation of carbon dioxide at room temperature and pressure. A portion of the NVR will typically consist of solid particles, which are shed from the metal surface of equipment. Generally, these solid particulates do not dissolve in high pressure or supercritical carbon dioxide and may be removed by filtration.

A further portion of the NVR typically includes non-volatile organic residue (NVOR). As used herein the term “non-volatile organic residue” refers to that portion of the NVR that is soluble in carbon dioxide at a certain temperature and pressure, typically those combinations that sustain dense phase (liquid, critical or supercritical) carbon dioxide. While not wanting to be bound to any particular chemical composition, examples of NVORs include heavy organics (C₁₀₊) such as aliphatic hydrocarbon-based heavy oils, halocarbons, and particulate matter that are soluble in carbon dioxide under certain conditions, but can form a second phase at atmospheric pressure and room temperature. Even in clean distribution systems (i.e., no solid particles), NVR present in the form of NVOR remains to be addressed. One potential source of NVOR is polymeric components including, but not limited to, gaskets and valve seats, which are part of the storage, delivery and purification system.

The solubility of NVOR contaminants in carbon dioxide is a strong function of density, which is in turn a function of temperature and pressure. At high pressures, this functionality is not simple, but in general, high-pressures and temperatures increase the solubility of NVORs in carbon dioxide. With decreases in temperature and pressure, the solubility of NVORs in carbon dioxide typically decreases. At ambient temperature and pressures, for example, NVORs generally precipitate from the carbon dioxide, forming an aerosol of gaseous carbon dioxide and suspended particulate contaminants. The suspended NVOR particles are believed to be mostly in the form of liquid droplets.

The formation of NVOR based aerosols is deleterious to a number of applications, including supercritical carbon dioxide-based wafer cleaning. In this application, carbon dioxide is brought to a temperature and pressure that exceeds the critical point (31° C. at approximately 73.7 atm) either prior to or after being injected into a wafer-cleaning tool. While this fluid is at conditions that exceed the critical point, NVOR tends to remain in solution and not deposit on the wafer. However, as the tool is depressurized, this NVOR becomes insoluble in carbon dioxide and deposits on the wafer as particles, producing a contaminated wafer.

Some applications use carbon dioxide snow to clean wafers. In those applications, liquid carbon dioxide is typically expanded to ambient pressure, producing a mixture of carbon dioxide snow and vapor. As the pressure associated with the liquid carbon dioxide is reduced, its temperature is also reduced. This reduced pressure and temperature can cause NVOR to precipitate, forming an aerosol. A significant portion of the particles or droplets that constitute this aerosol are in a size ranging from about 0.1 to about 2 microns, which is large enough to, for example, plug semiconductor features.

In these and other processes utilizing liquid or supercritical carbon dioxide, the processing conditions of the carbon dioxide will typically change. These changes in conditions can cause NVOR to exceed its solubility limit and precipitate from the carbon dioxide.

These precipitated NVOR particles or droplets can impinge or be taken up into the product and deposit onto its surface, ultimately interfering with the successful completion of the process and product (e.g., a workpiece or a pharmaceutical powder) quality.

A number of proposals have been made in the related art to eliminate the contaminants generated from the polymeric materials which are deleterious to the production of high purity products. Some of the proposals include the use of high durometer (i.e., very hard) materials. However, these materials may not be compatible with high purity carbon dioxide and non-volatile organic residues are commonly extracted therefrom.

U.S. Pat. No. 5,550,211, U.S. Pat. No. 5,861,473 and World Patent Document No 93/12161 describe processes for minimizing the off-gassing of polymeric sealing materials used in inhalers. In these systems, elastomeric and vulcanized elastomeric articles (except silicone rubber or polysiloxane) are placed in contact with at least one supercritical fluid to remove phthalates and polycyclic aromatic hydrocarbons (PAHs). The articles are treated until the contaminant level is below that of conventionally cleaned articles. Inhalers containing the treated polymeric sealing materials could use, for example, carbon dioxide as a propellant. However, non-volatile materials that could deposit on a workpiece, such as NVOR, are not removed. Further, no means is provided to prevent removed contaminants from re-depositing on the elastomer when the treatment chamber is depressurized.

World Patent Document No. 94/13733 discloses the decompression of an elastomeric material slowly at constant temperature before removing it from a supercritical carbon dioxide treatment chamber. This slow isothermal depressurization step prevents liquids from forming within the elastomer. The document states that as these liquids vaporize, they could cause the elastomeric article to rupture. In fact, this document is solely concerned with the removal of low molecular weight hydrocarbons to eliminate toxicity effects. Low molecular weight hydrocarbons, however, are not typically a source of NVOR and their presence does not impact particle deposition.

U.S. Pat. No. 5,756,657 discloses a process for removing at least one contaminant from polyethylene by dissolving the contaminants in a treatment chamber. Thereafter, the carbon dioxide and the dissolved contaminant emanated from the polyethylene are separated, thereby removing at least a portion of the contaminant from the polyethylene. As the treatment chamber is reduced to ambient pressure prior to removing the polyethylene, contaminants contained in the remaining carbon dioxide will separate out of solution and re-deposit on the polyethylene, contaminating it. No mechanism is provided to prevent this re-deposition.

U.S. Pat. No. 6,241,828 and World Patent Document No. 97/38044 relate to a two step process, wherein the contaminants are removed from elastomeric articles by a first solvent which is not in critical state. A second carbon dioxide solvent in critical state is utilized to remove the contaminated first solvent. One of the disadvantages associated with this process is that a non-toxic supercritical fluid such as carbon dioxide is necessary to remove the first solvent, which is too toxic to be left within the article.

One of the disadvantages associated with the aformentioned processes is that they do not recognize that supercritical fluids, such as carbon dioxide, can be used to extract contaminants that can be taken up into a product and deposited onto its surface, much less non-volatile organic residues. Further, the related art does not address the particle re-deposition on the articles that are to be treated.

U.S. Patent Application Publication No. 2003/0051741 (the '741 publication) relates to a process for removing surface contaminants from microelectronic components utilizing supercritical carbon dioxide. In particular, the microelectronic component is placed in a cleaning chamber and supercritical carbon dioxide is introduced therein. When the cleaning process is compete, the carbon dioxide is removed by displacement with another stream of clean carbon dioxide, thereby preventing contaminants from re-depositing onto the workpiece. However, this document does not recognize the need to remove NVOR from polymeric materials which are utilized in microelectronic component cleaning (i.e., does not recognize that polymeric materials generate NVOR which can then deposit on microelectronic components). Further, this document does not recognize the ability of supercritical carbon dioxide to remove contaminants that are embedded in a material and not located on its surface. Moreover, the '741 publication does not address the extraction of NVOR's from components which could affect the downstream cleaning of a workpiece, but rather addresses the removal of contaminants from the surface of a workpiece.

To overcome the disadvantages associated with the related art polymeric materials utilized in the pharmaceutical and semiconductor industries, a method and apparatus for pre-treatment of said polymeric materials is provided.

Another object of the invention is to extract the NVOR contaminant component from the polymeric materials and prevent their deposition on a workpiece disposed downstream.

It is a further object of the present invention to operate the NVOR extraction process such that NVOR does not re-deposit onto polymeric material as the extraction system is depressurized.

Other objects and advantages of the invention will become apparent to one skilled in the art upon review of the specification, figure and claims appended hereto.

### SUMMARY OF THE INVENTION

The foregoing objectives are met by the pretreatment method and apparatus of the present invention.

According to one aspect of the invention, a method of pretreating a polymeric material in a treatment chamber is provided. The method includes providing a polymeric material component into the treatment chamber and introducing a carbon dioxide fluid therein. The component is exposed to the carbon dioxide fluid to extract non-volatile organic residue contained in the component. The contaminated carbon dioxide fluid containing the extracted non-volatile organic residue is removed from the treatment chamber such that the organic residue does not deposit onto the component during treatment chamber depressurization. Thereafter, the component is removed from the treatment chamber.

According to another aspect of the invention an apparatus for pretreating a polymeric material is provided. The apparatus includes a treatment chamber configured to receive and treat a polymeric material component. A low-pressure storage source for carbon dioxide fluid is in communication with the treatment chamber to provide and expose the polymeric material component to the carbon dioxide fluid and extract non-volatile organic residue therefrom. An analyzer is disposed downstream of the treatment chamber to receive a contaminated carbon dioxide fluid stream exiting the treatment chamber and to determine when the treatment is complete based on the non-volatile organic residue having been reduced to a predetermined level.

### BRIEF DESCRIPTION OF THE FIGURES

The invention will be better understood by reference to the figures wherein like numbers denote same features throughout and wherein:

FIG. 1 is a schematic diagram of the pretreatment system and apparatus is provided; and

FIG. 2 is a graphical representation of NVOR concentration versus time for a Teflon™ product treated with dense phase carbon dioxide.

### DETAILED DESCRIPTION OF THE INVENTION

In processes utilizing dense phase (liquid, critical or supercritical) carbon dioxide the conditions (pressure, temperature or phase) of the carbon dioxide fluid will invariably change. These changes in conditions can cause NVOR to exceed its solubility limit and precipitate from the carbon dioxide.

Particular manufacturing processes, such as semiconductor and pharmaceutical processes have a high cleanliness requirement. For example, semiconductor workpieces (i.e., wafers) require ultra-high-purity ingredients during most processing steps (e.g., photoresist removal) in order to reduce or eliminate deleterious effects on the final workpiece. However, the selection of ingredients such as solvents and rinse fluids, as well as the clean room may not be sufficient in and of itself. Contaminants generated from the associated polymeric material components (e.g., gaskets, valves located within or upstream of the tool/process chamber) have proven to compromise the manufacturing process.

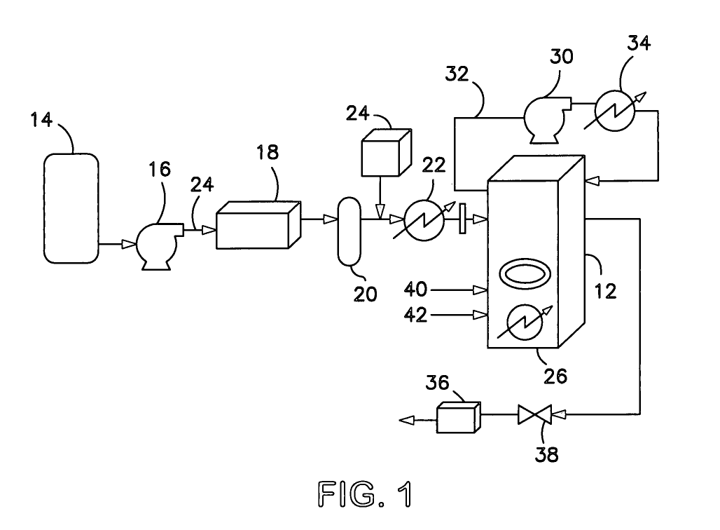

With reference to FIG. 1, the method and apparatus of pretreating polymeric material components is described. A polymeric material component 10 is placed in a treatment chamber 12, which is subsequently sealed. Treatment chamber 12 is preferably constructed of electropolished stainless steel with a minimum number of threaded ports disposed therein for supplying various constituent ingredients to carry out the desired processes. It will be understood by those skilled in the art that the treatment chamber is disposed in a clean room environment. Preferably, treatment chamber 12 is disposed within a class 100 clean room, containing no more than 100 particles greater than 0.5 micron per cubic foot of atmosphere.

Carbon dioxide fluid is stored in one or more storage vessels 14 upstream from treatment chamber 12 as liquid at low pressure ranging from about 300 to 1000 psig. The fluid is conveyed from storage vessel 14 via pump 16, which pressurizes the fluid to an elevated pressure of between about 300 psig and 20,000 psig, preferably ranging from about 300 psig and 5,000 psig and more preferably ranging from about 800 psig and 1500 psig. The carbon dioxide fluid is conveyed to a purification station 18. Depending on the source carbon dioxide purity, the purification system can simply be, for example, a filtration device such as a 0.1 micron stainless steel filter. Optionally, a second purification station 20 can be installed in-line to remove any NVOR contained in the carbon dioxide. This second purification station can be selected, for example, from among catalytic oxidation devices, distillation columns, or adsorption units which remove NVOR impurities to levels ranging from about 0.01 and about 50 parts per million (ppm), preferably about 0.05 and 10 ppm and most preferably 0.1 and 2 ppm.

The purified carbon dioxide is conveyed downstream of purification station 18, where it may be heated or cooled by heat exchange system 22, to a temperature ranging from about 0 and 400° F., and preferably about 80 and 250° F., prior to introducing said carbon dioxide into treatment chamber 12. Optionally, a modifier source 24 is utilized to supply a modifier or mixture of modifiers to the high purity carbon dioxide stream at any point on the line upstream of treatment chamber 12. The amount of modifier can be between about 0 and 49 weight percent, and preferably about 0 to 10 weight percent. The modifier can be selected from alcohols, acids, bases, surfactants, or other fluids and the mixtures thereof.

The carbon dioxide stream is thereafter introduced into treatment chamber 12, which is preferably pressurized in order to prevent carbon dioxide from solidifying or partially solidifying. Thus, treatment chamber 12 is pressurized to a pressure that exceeds the triple point pressure of carbon dioxide (i.e., 75.1 psia).

The polymeric material component within treatment chamber 12 is treated with the incoming high purity carbon dioxide for period ranging from about 0.1 hours to 92 hours, preferably about 0.5 to 24 hours, and most preferably between about 0.5 to 6 hours to remove non-volatile organic residues therefrom. During the treatment period, additional heating or cooling may be supplied from heat exchanger 26, disposed in or in proximate location to treatment chamber 12 to maintain the treatment chamber at the desired temperature.

During the treatment operation, the carbon dioxide within the treatment chamber, may be optionally agitated by circulating the carbon dioxide fluid into and out of treatment chamber 12. Accordingly, carbon dioxide is removed from treatment chamber 12 via pump 30 disposed on circulation loop 32, and pumped at an elevated pressure and returned to the treatment chamber. Additionally, a heat exchanger 34 may be placed on the recirculation loop to provide the adequate thermal medium so as to maintain the circulating stream at the requisite temperature.

The carbon dioxide fluid extracts NVOR impurities from the polymeric material component, and in turn the contaminated carbon dioxide is removed from the treatment chamber. The removal of the contaminated carbon dioxide from the treatment chamber may be fashioned in a continuous manner where the contaminated carbon dioxide is continuously replaced with high-purity carbon dioxide. This technique lends itself to the analysis and monitoring of the non-volatile organic residue level effluent (i.e., contaminated carbon dioxide fluid) removed from the treatment chamber. In furtherance of the analysis, an analyzer 36 is placed downstream of the treatment chamber to monitor the removed carbon dioxide stream, and determine when the treatment is complete based on a predetermined level of NVOR in the stream which is found to be acceptable. Typically, the acceptable NVOR level ranges from 0.01 ppm and 50 ppm, and preferably ranges from 0.1 to 2 ppm. Those skilled in the art will readily recognize that the analytical methods employed may encompass particle and gravimetric analysis, as well as gas and liquid chromatography.

Upon reaching an acceptable NVOR concentration in the effluent, treatment chamber 12 is evacuated in such a manner that the NVOR contained in the remaining carbon dioxide does not re-deposit on the polymeric material component. There are number of mechanisms by which this objective may be achieved. By way of example, a discharge valve 38 located on the line, downstream of treatment chamber 12 is opened such that the treatment chamber is slowly evacuated. The temperature associated with the carbon dioxide contained in the treatment chamber 12 is maintained at an elevated level by manipulating heat exchanger 26, to prevent carbon dioxide and NVOR condensation from occurring. Another mechanism includes depressurizing the treatment chamber and introducing fresh carbon dioxide or an inert gas, such as argon at elevated pressure, via entry ports 40/42 in treatment chamber 12 to displace the contaminated carbon dioxide therein. In addition, any other technique for sweeping extracted NVOR away from the polymeric component which prevents the NVOR from coming out of solution with carbon dioxide, will be understood to be within the scope of the present invention. Upon reducing the NVOR impurities to a predetermined level, the article/component is removed from the treatment chamber, and is ready to be utilized in the semiconductor or pharmaceutical application where ultra-high-purity gases are employed.

A method for pre-treating a polymeric material in accordance with the present invention will be further described in detail with the reference to the following example, which, should not be construed as limiting the invention.

### EXAMPLE

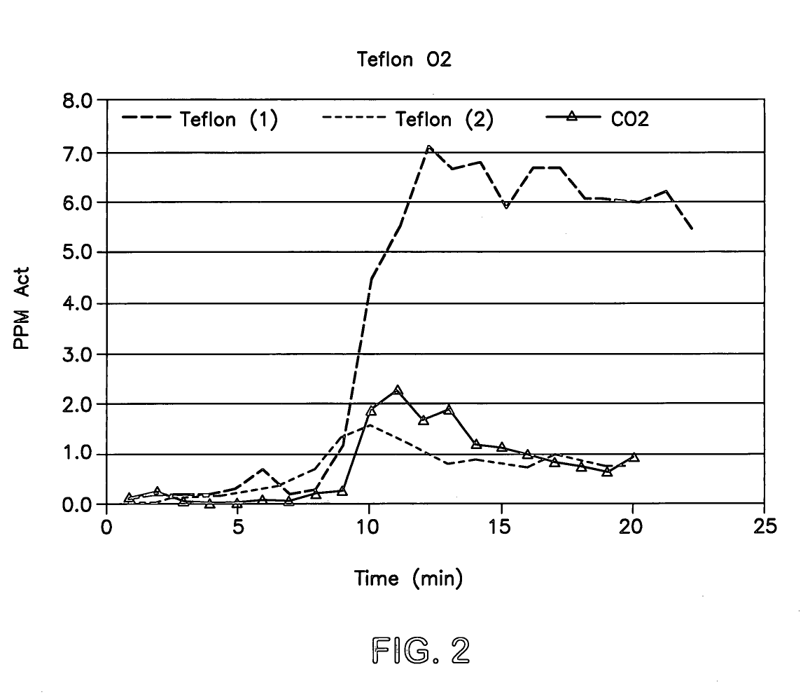

A polytetrafluoroethylene (Teflon™ by Dupont) material was introduced into a treatment chamber and initially treated with dense phase carbon dioxide. As shown in FIG. 2, the CO₂ introduced therein extracted NVOR from the teflon material. The NVOR concentration in the effluent CO₂ from the treatment chamber was at least 7.0 ppm during treatment, while the CO₂ introduced into the treatment chamber contained at most 2.0 ppm of NVOR. Thereafter, the treatment chamber had been depressurized and fresh carbon dioxide was introduced therein to prevent re-deposition. As can be seen the NVOR concentration in the effluent was 1.5 ppm, which is approximately the same as the NVOR concentration in the CO₂ introduced into the treatment chamber.

While the invention has been described in detail with reference to a particular embodiment, it will become apparent to one skilled in the art that various changes and modifications can be made, and equivalents employed, without departing from the scope of the appended claims.

1. A method of pre-treating a polymeric material in a treatment chamber, comprising:
providing a polymeric material component into said treatment chamber;
introducing a dense phase carbon dioxide fluid into said treatment chamber;
exposing said polymeric material component to said carbon dioxide fluid to extract non-volatile organic residue contained in said polymeric material component;
removing a contaminated carbon dioxide fluid containing said extracted non-volatile organic residue from said treatment chamber such that a portion of the non-volatile organic residue does not deposit onto said polymeric material component by depressurization of said treatment chamber; and
removing the polymeric material component from said treatment chamber.

2. The method of claim 1, wherein said polymeric material component is utilized in a semiconductor process after pre-treatment.

3. The method of claim 1, wherein the deposition of said non-volatile organic residue on said polymeric material component is controlled.

4. The method of claim 1, wherein a portion of the non-volatile organic residue is removed from said treatment chamber by adding high purity carbon dioxide to displace said contaminated carbon dioxide fluid.

5. The method of claim 1, wherein a portion of the non-volatile organic residue is removed from the treatment chamber by adding an inert substance to displace said contaminated carbon dioxide fluid.

6. The method of claim 1, further comprising: adding a modifier to the carbon dioxide fluid, wherein said modifier is selected from the group consisting of alcohols, acids, bases, surfactants and mixtures thereof.

7. The method of claim 1, further comprising: purifying the carbon dioxide fluid upstream of said treatment chamber to remove non-volatile organic residue.

8. The method of claim 1, wherein said carbon dioxide fluid is ultra-high purity.

9. The method of claim 1, further comprising: heating or cooling the carbon dioxide fluid upstream of said treatment chamber.

10. The method of claim 1, further comprising: pressurizing said treatment chamber to above the triple point of said carbon dioxide fluid.

11. The method of claim 1, wherein said carbon dioxide fluid is circulated in and out of said treatment chamber to provide an agitated fluid therein.

12. The method of claim 1, further comprising: analyzing the stream of carbon dioxide fluid removed from said treatment chamber to determine its non-volatile organic residue content.

13. The method of claim 1, further comprising: opening a discharge valve disposed downstream of said treatment chamber in a controlled manner and increasing the temperature within said treatment chamber to remove said contaminated carbon dioxide fluid therein.

14. An apparatus for pre-treating a polymeric material, comprising:
a treatment chamber configured to receive and treat a polymeric material component;
a low-pressure storage source for carbon dioxide fluid in communication with said treatment chamber to provide and expose said polymeric material component to a carbon dioxide fluid and extract non-volatile organic residue therefrom;
an analyzer disposed downstream of said treatment chamber to receive a contaminated carbon dioxide fluid stream exiting said treatment chamber and to determine when the treatment is complete based on the non-volatile organic residue having been reduced to a predetermined level.

15. The apparatus of claim 14, further comprising: a purification system disposed between said low-pressure storage source and said treatment chamber to remove the non-volatile residue impurities within the carbon dioxide fluid delivered to the treatment chamber.

16. The apparatus of claim 14, further comprising a recirculation system in communication with said treatment chamber, to maintain said carbon dioxide fluid in an agitated state.

17. The apparatus of claim 14, further comprising: an optional modifier system upstream of said treatment chamber to provide a modifier selected from the group consisting of alcohols, acids, bases, surfactants and mixtures thereof.
